(19) United States
(12) Patent Application Publication
(10) Pub. No.: US 2005/0069079 A1
(43) Pub. Date: Mar. 31, 2005

(54) Modular reactor containment system

(76) Inventors: Charles Edward Boardman, Saratoga, CA (US); Jimmy Frank Galtman, Gilroy, CA (US); Ronald D. Mokler, Santa Clara, CA (US)

Correspondence Address: Patrick W. Rasche;Armstrong Teasdale LLP, Suite 2600, One Metropolitan Square, St. Louis, MO, 63102, US

(21) Appl. No.: 10/661,847

(22) Filed: Sep. 12, 2003

(51) Int. Cl. G21C 1/04

(52) U.S. Cl. 376/347; 376/437

(57) ABSTRACT

An apparatus for supporting fuel assemblies in a reactor pressure vessel including a core includes a plurality of support beams and at least one removable support plate disposed on at least one of the plurality of support beams.

### BACKGROUND OF THE INVENTION

This invention relates generally to nuclear reactors, and more particularly, to removable components in nuclear boiling water reactors.

One known boiling water reactor (BWR) includes a reactor pressure vessel (RPV) positioned in a containment building or vessel, and a containment cooling system (CCS). A typical containment vessel includes both a drywell and an enclosed wetwell disposed in the containment vessel. The wetwell provides an additional source of cooling water for the reactor in the event of a pipe rupture or loss of coolant accident (LOCA). The CCS includes a passive containment cooling system (PCCS) having a heat exchanger submerged in a cooling pool located outside the containment vessel.

In the event of a LOCA, high-pressure fluid or steam is released from the RPV into the containment vessel. The steam is retained in the containment vessel, flows to the PCCS and is condensed in the PCCS heat exchanger. The steam condensate collected in the condenser is returned to the RPV or the containment vessel. Inside the RPV, the condensate is turned into steam by core decay heat and the steam flows back into the containment vessel. This produces a continuous process by which the reactor core is cooled by water over a period of time following the LOCA.

The containment vessel, in turn, is sized and configured to receive relatively high pressure and high temperature steam in the event of the LOCA. The containment vessel or building is typically a large volume structure made of thick reinforced concrete configured to contain a steam release. The large volume provides an expansion area for depressurization and control of the steam. The containment vessel is configured to contain low pressures, of about 2 atmospheres (atm) to about 3 atm (about 202 kilopascals (kPa) to about 303 kPa). The containment vessel also is effective as a radioactive boundary for containing the radioactive steam. Construction of the containment vessel and the support pad for the containment vessel is a complex event requiring significant time and resources at the reactor site.

In some applications, a reactor, such as a boiling water reactor (BWR) can be placed within a close fitting steel containment vessel. When a close fitting steel containment is combined with a passive closed loop isolation condenser and a natural circulating reactor system that contains a large water inventory, primary system leaks cannot uncover the core. Thus, LOCA may be eliminated from the design basis spectrum along with many of the safety systems that are common to large plant designs. In order for the small BWR to be feasible, control rod drives must be placed within the reactor vessel and provisions made that allow the control rod drives to be removed and replaced from above the core when necessary.

### BRIEF SUMMARY OF THE INVENTION

In one aspect, an apparatus for supporting fuel assemblies in a reactor pressure vessel including a core is provided. The apparatus includes a plurality of support beams and at least one removable support plate disposed on at least one of the plurality of support beams.

In another aspect, a support plate is provided. The support plate includes a top surface, a bottom surface spaced apart from the top surface by a thickness, the bottom surface having at least one groove, a guide tube opening through the thickness, and at least one flow passage through the thickness.

In a further aspect, a nuclear reactor is provided. The nuclear reactor includes a reactor pressure vessel, a reactor core located inside the reactor pressure vessel, and a core plate located inside the reactor pressure vessel. The core plate includes a plurality of support beams and at least one removable support plate disposed on at least one of the plurality of support beams.

### BRIEF DESCRIPTION OF THE DRAWINGS

FIG. 1 is a sectional view of a boiling water nuclear reactor pressure vessel in accordance with an embodiment of the present invention.

FIG. 2 is a top perspective view of a removable core support plate.

FIG. 3 is a bottom view of the removable core support plate.

FIG. 4 is a top view of at least one core support plate disposed on a plurality of core support beams.

FIG. 5 illustrates at least one core support plate and a plurality of core support beams forming a core support for the boiling water nuclear of FIG. 1.

FIG. 6 is a perspective view of at least one fuel support block removably mounted to the core support plate.

FIG. 7 is a cross-sectional view of the support block mounted on the core support plate.

### DETAILED DESCRIPTION OF THE INVENTION

A boiling water nuclear reactor with a compact metal containment vessel in accordance with an exemplary embodiment of the present invention is described below in more detail. The compact containment vessel is smaller than known containment vessels and can be shop fabricated off-site for quick installation on-site. The high pressure compact steel containment vessel is used instead of the known relatively large and expensive concrete or steel containment vessels having a large suppression pool of water that are designed with relatively low pressure ratings. The compact containment vessel has a relatively high pressure rating.

The boiling water reactor with compact, dry containment vessel also employs a simple safety system which isolates and retains coolant inventory following a loss-of coolant accident (LOCA). The safety system is capable of maintaining core cooling and decay heat transfer using isolation condensers and equalizing lines without requiring coolant make-up from external sources.

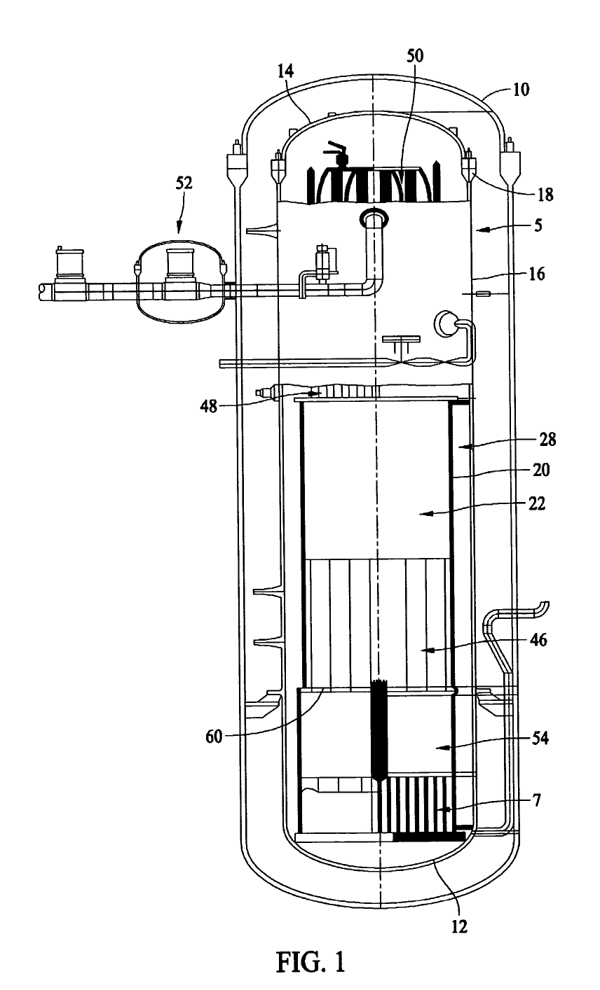

FIG. 1 is a sectional view of a natural circulating boiling water nuclear reactor pressure vessel (RPV) 5 with bottom mounted internal control rod drive mechanism 7 disposed within a close fitting high pressure steel containment vessel 10. RPV 5 has a generally cylindrical shape and is closed at one end by a bottom head 12 and at its other end by a removable top head 14. A side wall 16 extends from bottom head 12 to top head 14. Side wall 16 includes a top flange 18. Top head 14 is attached to top flange 18. A cylindrically shaped core shroud 20 surrounds a reactor core 22. An annulus 28 is formed between shroud 20 and side wall 16.

Heat is generated within a naturally circulating core 22, which includes fuel bundles 46 of fissionable material. Water circulated up through core 22 is at least partially converted to steam. Steam separators 48 separate steam from water, which is recirculated. Residual water is removed from the steam by steam dryers 50. The steam exits RPV 5 through a steam outlet 52 near vessel top head 14.

The amount of heat generated in core 22 is regulated by inserting and withdrawing control rods 54 of neutron absorbing material, such as for example, hafnium. To the extent that control rod 54 is inserted into fuel bundle 46, it absorbs neutrons that would otherwise be available to promote the chain reaction which generates heat in core 22. Control rod guide tubes 56 maintain the vertical motion of control rods 54 during insertion and withdrawal. Control rod drive mechanism 7 is located within shroud 20 below core 22. Fuel bundles 46 are aligned by a core plate 60 located at the base of core 22. Core plate 60 is supported by core support beams which are attached to shroud 20.

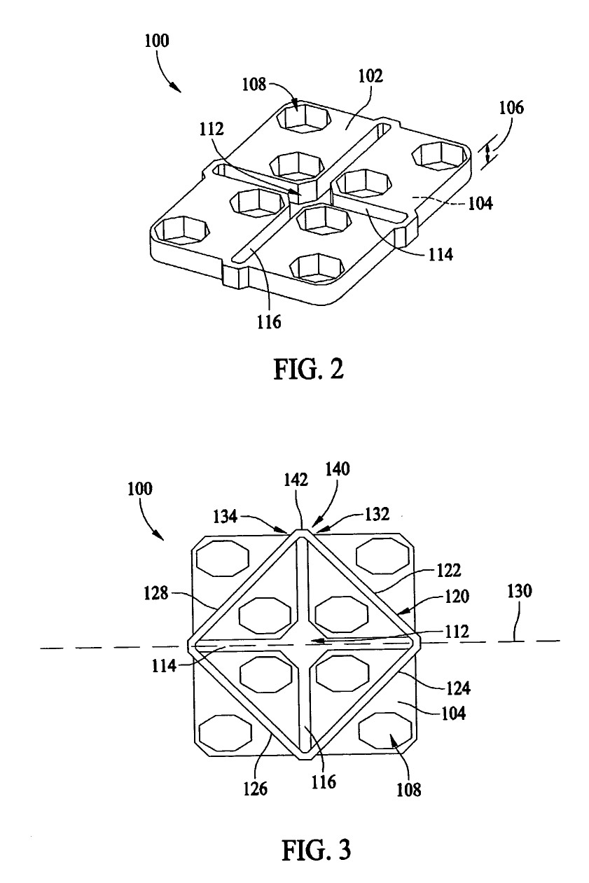

FIG. 2 is a top perspective view of a removable core support plate 100. Removable core support plate 100 has a top surface 102 and a bottom surface 104 spaced apart from top surface 102 by a thickness 106. Removable core support plate 100 has at least one coolant flow passage 108 and at least one guide tube opening 112.

In one embodiment, guide tube opening 112 includes cruciform shaped slots 114 and 116 for receiving similarly shaped control rod guide tubes. In one embodiment, cruciform shaped slots 114 and 116 are substantially perpendicular to each other. Cruciform shaped slots 114 and 116 in core support plate 100 horizontally position the top of the cruciform shaped control rod drive guide tubes and the upper end of the control rod drive (not shown) with its integral cruciform shaped guide tube (not shown). At the lower end of the control rod drive/guide tube assembly a hydraulic coupling is used to position and support the control rod drive mechanism and to connect it to the hydraulic lines embedded within the control rod drive support plate located near the bottom of the reactor vessel.

Other control rod drive candidates include replacing the electric motor with a hydraulic drive (water turbine) and revising it as necessary to operate as an internal drive. In an alternative embodiment, a canned motor and all necessary power and control signals are transferred through reactor vessel 12 without contact by using coil type electronic couplings.

FIG. 3 is a bottom view of removable core support plate 100 including a plurality of grooves 120 formed in bottom surface 104. In an exemplary embodiment, bottom surface 104 has a first groove 122, a second groove 124, a third groove 126, and a fourth groove 128. In one embodiment, grooves 122, 124, 126, and 128 are positioned around slots 114 and 116. In another embodiment, grooves 122 and 126 are substantially parallel to each other, or alternatively, grooves 124 and 128 are substantially parallel to each other. In a further embodiment, each groove 122, 124, 126 and 128 extends along bottom surface 104 at an angle of approximately 45° with respect to an axis 130. In a further embodiment, grooves 122, 124, 126 and 128 form one of a plurality of patterns and extend along bottom surface 104 in one of a plurality of orientations with respect to axis 130. As shown in FIG. 3, one end 132 of first groove 122 intersects with one end 134 of fourth groove 128. In one embodiment, core support plate 100 includes an intersection portion 140 extending from thickness 106 of core support plate 100. Intersection portion 140 has an opening 142 and provides additional surface area for intersecting grooves 122, 124, 126 and 128.

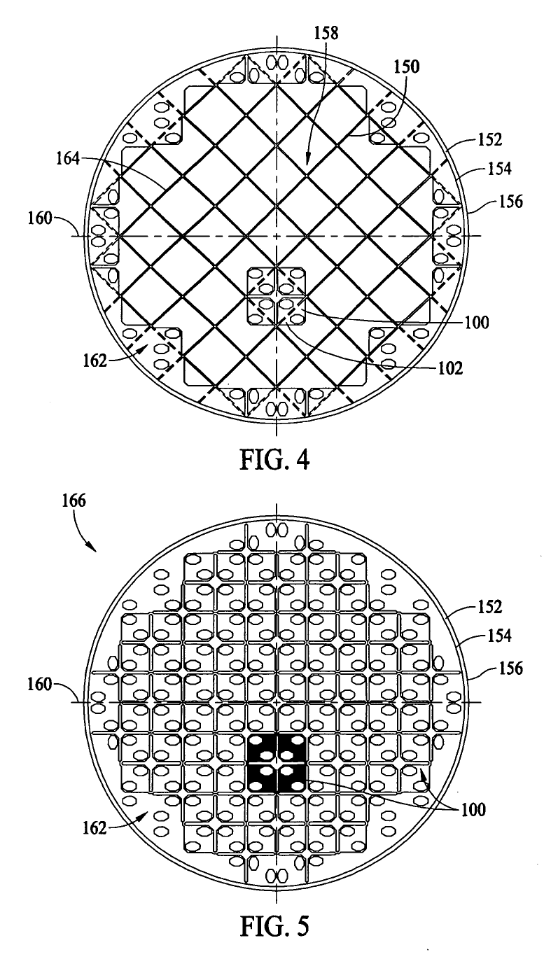

FIG. 4 is a top view of at least one support plate 100 removably disposed on a plurality of core support beams 150. Support beams are connected to and supported by RPV 5. In one embodiment, core support beams 150 extend between a support ring 152. Support beams 150 extend from an inner periphery 154 of support ring 152 and intersect one another to form a support beam matrix 158. Support ring 152 has an outer periphery 156. In one embodiment, core support beams 150 extend between inner periphery 154 of support ring 152 at an angle of approximately 45° with respect to an axis 160. In another embodiment, support ring 152 includes partial platelets 162 extending around inner periphery 154 of support ring 152 to locate and support core support plates 100 and to transition core support plates 100 from a square to a round configuration.

Core support plates 100 are individually located, supported, and fixed in position by grooves 122, 124, 126 and 128 in bottom surface 104 which receive corresponding core support beams 150. In one embodiment, core support beams 100 have mating grooves or protrusions (not shown) machined into the core support beams 100 after the core support beam structure has been welded together and heat treated. Protrusions extend along a length of a core support beam 150 and are receivable within matching grooves 122, 124, 126, and 128 of core support plate 100. Opening 142 of intersection portion 140 allows intersecting core support beams disposed in grooves 120 to extend beyond core support plate 100. The interlocking of grooves and core support beams 150 provide accurate and secure lateral spacing of core support plates 100 within support ring 152. FIG. 5 illustrates at least one removable core support plate 100 and a plurality of core support beams 150 forming a core support 166 for core 22 of reactor 5.

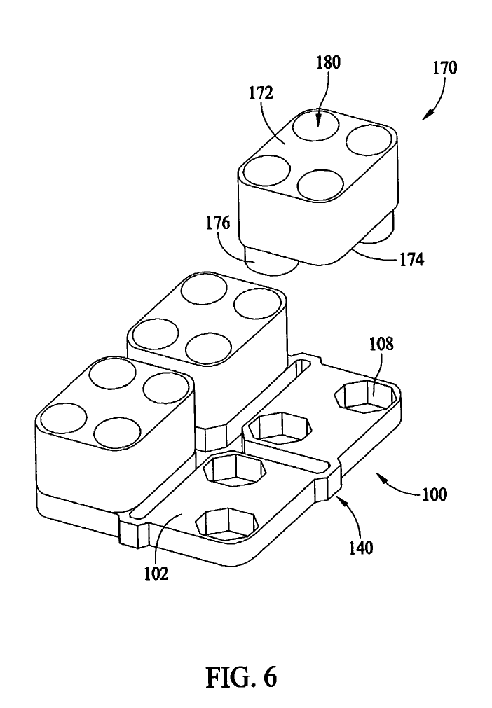

FIG. 6 is a perspective view of at least one fuel support block 170 removably mounted to core support plate 100. In an exemplary embodiment, at least four support blocks 170 are mounted on top surface 102 of a single core support plate 100. Support blocks 170 include a top surface 172 and a bottom surface 174. At least one flow inlet portion 176 extends from bottom surface 174. In an exemplary embodiment, support block 170 includes two offset inlet portions 176 each receivable within flow passage 108 of core support plate 100. In one embodiment, flow inlet portion 176 is a machined nipple receivable within a matching flow passage 108 of core support plate 100. Inlet portions 176 match and fit into flow passages 108 of core support plates 100 to accurately and securely locate core support blocks 170 on core support plates 100.

Support block 170 has at least one flow outlet 180. As shown in FIG. 5, each block 170 has at least four flow outlets 180. In one embodiment, at least one fuel assembly (not shown) is mounted on top surface 172 of block 170 above at least one flow outlet 180. Some fuel assemblies do not receive fluid flow because they are located directly above one of core support beams 150. Therefore, each support block 170 includes internal flow passages (not shown in FIG. 6) that provide unobstructed coolant flow from two offset inlet portions 176 to the four fuel assemblies that rest on each support block 170.

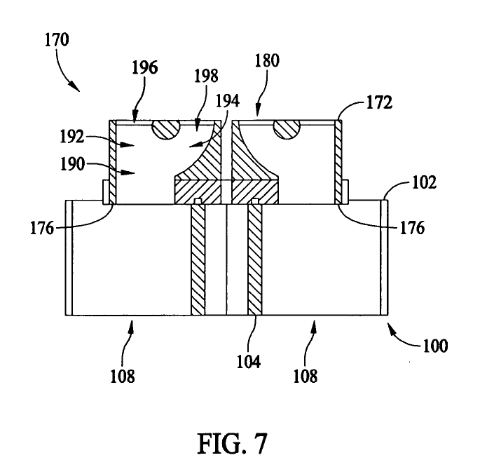

FIG. 7 is a cross-sectional view of support block 170 mounted on a core support plate 100. Each support block 170 has an internal flow passage 190 providing flow communication from inlet portion 176 to flow outlet 180. In one embodiment, internal flow passage 190 directs fluid flow into a first channel 192 and a second channel 194. First channel 192 provides flow communication from inlet portion 176 to a first flow outlet 196 and second channel 194 provides flow communication from inlet portion 176 to a second flow outlet 198. Support blocks 170 allow unobstructed coolant flow from two offset inlet portions 176 to the four fuel assemblies that each block 170 supports.

The cruciform shaped guide tube 112 and associated control rod drive mechanism 7 can be removed from the core region in the same manner as the control rods 54 once the necessary fuel assemblies, support blocks 170, and core support plates 100 have been removed. The fuel assemblies, fuel support blocks 170, and core support plates 100 can be removed above core 22 to allow the control rod drive mechanism 7 to also be removed above core 22 and replaced when necessary.

The control rod drive described above is hydraulically actuated by flow that enters the bottom of the drive through a hydraulic coupling. However, other types of internal drives such as a water turbine powered Fine Motion control rod drive could be utilized.

While the invention has been described in terms of various specific embodiments, those skilled in the art will recognize that the invention can be practiced with modification within the spirit and scope of the claims.

1. An apparatus for supporting fuel assemblies in a reactor pressure vessel including a core, said apparatus comprising:
a plurality of support beams; and
at least one removable support plate disposed on said plurality of support beams, each said removable support plate comprising at least one groove configured to mate with one of said plurality of support beams.

2. The apparatus according to claim 1 wherein said at least one removable support plate and said plurality of support beams form a core support.

3. The apparatus according to claim 1 further comprising a support ring having an inner periphery and an outer periphery, said plurality of support beams extending between said inner periphery, said plurality of support beams intersecting one another to form a support beam matrix.

4. The apparatus according to claim 1 wherein said at least one removable support plate is configured to be removed from above the core.

5. The apparatus according to claim 1 wherein each of said plurality of support beams comprise a protrusion extending along a length thereof, said protrusion receivable within said at least one groove.

6. The apparatus of claim 1 wherein said at least one removable support plate comprising at least one support plate flow passage.

7. The apparatus according to claim 6 wherein said at least one removable support plate comprising at least one removable support block disposed thereon, said removable support block having at least one support block flow passage in flow communication with one of said at least one support plate flow passage.

8. The apparatus according to claim 7 wherein said removable support block comprising at least one flow inlet portion extending from one side of said removable support block, said at least one flow inlet portion providing flow communication to one of said at least one support block flow passage, said at least one flow inlet portion receivable within one of said at least one support plate flow passage.

9. A support plate comprising:
a top surface;
a bottom surface spaced apart from said top surface by a thickness, said bottom surface having at least one groove configured to locate said support plate along corresponding support beams;
a guide tube opening through said thickness; and
at least one flow passage through said thickness.

10. The support plate according to claim 9 wherein said guide tube opening includes at least one cruciform shaped slot, said bottom surface has a first groove, a second groove, a third groove and a fourth groove, said first, second, third and fourth grooves positioned around said guide tube opening.

11. The support plate according to claim 10 wherein at least two of said first groove, second groove, third groove and fourth groove extend along said bottom surface substantially parallel to each other, and
wherein one end of at least one of said first groove, second groove, third groove and fourth groove intersects with one end of at least one of said first groove, second groove, third groove and fourth groove.

12. The support plate according to claim 9 further comprising a removable support block having a flow inlet portion extending from one side of said removable support block, said flow inlet portion providing flow communication to another side of said removable support block, said flow inlet portion receivable within said at least one flow passage.

13. A nuclear reactor comprising:
a reactor pressure vessel;
a reactor core located inside said reactor pressure vessel; and
a core plate located inside said reactor pressure vessel, said core plate comprising:
a plurality of support beams; and
at least one removable support plate disposed on said plurality of support beams, each said removable support plate comprising at least one groove configured to mate with one of said plurality of support beams.

14. (cancelled)

15. The nuclear reactor according to claim 13 wherein said at least one removable support plate comprises at least one support plate flow passage.

16. The nuclear reactor according to claim 15 wherein said at least one removable support plate comprises at least one removable support block disposed thereon, said at least one removable support block comprising at least one support block flow passage in flow communication with one of said at least one support plate flow passage.

17. The nuclear reactor according to claim 16 wherein said at least one removable support block comprises at least one inlet flow projection extending from one side of said at least one removable support block and a at least one flow outlet extending on an opposite side of said at least one removable support block, said at least one inlet flow projection receivable within one of said at least one support plate flow passage.

18. The nuclear reactor according to claim 17 wherein said at least one removable support block comprises at least one internal flow passage providing flow communication between one of said at least one inlet flow projection and one of said at least one flow outlet.

19. The nuclear reactor according to claim 18 wherein said at least one internal flow passage directs flow into a first channel and a second channel, said first and second channels located within said at least one removable support block.

20. The nuclear reactor according to claim 19 wherein said first channel has a first flow outlet and said second channel has a second flow outlet.
